(19) United States
(12) Patent Application Publication
(10) Pub. No.: US 2015/0179296 A1
(43) Pub. Date: Jun. 25, 2015

(54) COMPOSITION FOR SOLAR CELL ELECTRODES AND ELECTRODE FABRICATED USING THE SAME

(71) Applicant: Samsung SDI Co., Ltd., Yongin-si (KR)

(72) Inventors: Sang Hee PARK, Uiwang-si (KR); Tae Joon KIM, Uiwang-si (KR); Hun Gyu SONG, Uiwang-si (KR); Hyun Jin KOO, Uiwang-si (KR)

(21) Appl. No.: 14/487,606

(22) Filed: Sep. 16, 2014

(30) Foreign Application Priority Data
Dec. 20, 2013 (KR) 10-2013-0160767

(51) Int. Cl. H01B 1/16; C09D 5/24

(52) U.S. Cl. CPC H01B 1/16; C09D 5/24

(57) ABSTRACT

A composition for solar cell electrodes includes a silver (Ag) powder, a glass frit containing elemental silver (Ag) and at least one element of lead (Pb) and bismuth (Bi), and an organic vehicle. The glass frit has a mole ratio of Ag to Pb ranging from about 1:0.1 to about 1:50, or a mole ratio of Ag to Bi ranging from about 1:0.1 to about 1:20.

### CROSS-REFERENCE TO RELATED APPLICATION

Korean Patent Application No. 10-2013-0160767, filed on Dec. 20, 2013, in the Korean Intellectual Property Office, and entitled: “Composition For Solar Cell Electrodes and Electrode Fabricated Using the Same,” is incorporated by reference herein in its entirety.

### BACKGROUND

1. Field

Embodiments relate to a composition for solar cell electrodes and electrodes fabricated using the same.

2. Description of Related Art

Solar cells generate electricity using the photovoltaic effect of a p-n junction, which converts photons of sunlight into electricity. In the solar cell, front and rear electrodes are formed on upper and lower surfaces of a semiconductor wafer or substrate with the p-n junctions, respectively. Then, the photovoltaic effect at the p-n junction is induced by sunlight entering the semiconductor wafer. Electrons generated by the photovoltaic effect at the p-n junction provide electric current to the outside through the electrodes. The electrodes of the solar cell are formed on the wafer by applying, patterning, and baking an electrode composition.

### SUMMARY

Embodiments are directed to a composition for solar cell electrodes, the composition including a silver (Ag) powder, a glass frit containing elemental silver (Ag) and containing at least one of lead (Pb) and bismuth (Bi), and an organic vehicle. The glass fit has a mole ratio of Ag to Pb ranging from about 1:0.1 to about 1:50, or a mole ratio of Ag to Bi ranging from about 1:0.1 to about 1:20.

The glass frit may further include at least one selected from tellurium (Te), phosphorus (P), germanium (Ge), gallium (Ga), cerium (Ce), iron (Fe), lithium (Li), silicon (Si), zinc (Zn), tungsten (W), magnesium (Mg), cesium (Cs), strontium (Sr), molybdenum (Mo), titanium (Ti), tin (Sn), indium (In), vanadium (V), ruthenium (Ru), barium (Ba), nickel (Ni), copper (Cu), sodium (Na), potassium (K), arsenic (As), cobalt (Co), zirconium (Zr), manganese (Mn), neodymium (Nd), chromium (Cr), and aluminum (Al).

The elemental silver (Ag) may originate from at least one silver compound selected from silver cyanide, silver nitrate, silver halide, silver carbonate, and silver acetate.

The glass frit may be formed of a silver compound and at least one metal oxide selected from lead (Pb) oxide and bismuth (Bi) oxide.

The metal oxide may further include at least one metal oxide selected from tellurium (Te), phosphorus (P), germanium (Ge), gallium (Ga), cerium (Ce), iron (Fe), lithium (Li), silicon (Si), zinc (Zn), tungsten (W), magnesium (Mg), cesium (Cs), strontium (Sr), molybdenum (Mo), titanium (Ti), tin (Sn), indium (In), vanadium (V), ruthenium (Ru), barium (Ba), nickel (Ni), copper (Cu), sodium (Na), potassium (K), arsenic (As), cobalt (Co), zirconium (Zr), manganese (Mn), neodymium (Nd), chromium (Cr), and aluminum (Al) oxides.

The composition may include about 60 wt % to about 95 wt % of the silver powder, about 0.1 wt % to about 20 wt % of the glass fit, and about 1 wt % to about 30 wt % of the organic vehicle.

The glass frit may contain about 0.1 mole % to about 50 mole % of the elemental silver (Ag) based on total moles of the glass frit.

The glass frit may have an average particle diameter (D50) of about 0.1 μm to about 10 μm.

The composition may further include at least one additive selected from a dispersant, a thixotropic agent, a plasticizer, a viscosity stabilizer, an anti-foaming agent, a pigment, a UV stabilizers, an antioxidants, and a coupling agents.

Embodiments are also directed to a solar cell electrode prepared from the composition for solar cell electrodes.

### BRIEF DESCRIPTION OF THE DRAWING

Features will become apparent to those of skill in the art by describing in detail exemplary embodiments with reference to the attached drawing in which:

FIG. 1 illustrates a schematic view of a solar cell in accordance with an embodiment.

### DETAILED DESCRIPTION

Example embodiments will now be described more fully hereinafter with reference to the accompanying drawing; however, they may be embodied in different forms and should not be construed as limited to the embodiments set forth herein. Rather, these embodiments are provided so that this disclosure will be thorough and complete, and will fully convey exemplary implementations to those skilled in the art. In the drawing figure, the dimensions of layers and regions may be exaggerated for clarity of illustration.

Composition for Solar Cell Electrodes

A composition for solar cell electrodes includes a silver (Ag) powder; a glass frit containing elemental silver (Ag) and includes at least one of lead (Pb) and bismuth (Bi); and an organic vehicle, wherein the glass frit has a mole ratio of Ag to Pb ranging from about 1:0.1 to about 1:50, or a mole ratio of Ag to Bi ranging from about 1:0.1 to about 1:20.

Now, each component of the composition for solar cell electrodes will be described in more detail.

Silver Powder

The composition for solar cell electrodes according to embodiments may include a silver (Ag) powder as a conductive powder. The particle size of the silver powder may be on a nanometer or micrometer scale. For example, the silver powder may have a particle size of dozens to several hundred nanometers, or several to dozens of micrometers. In some implementations, the silver powder may be a mixture of two or more types of silver powders having different particle sizes.

The silver powder may have a spherical, flake or amorphous shape.

The silver powder may an average particle diameter (D50) of about 0.1 μm to about 10 μm, for example, about 0.5 μm to about 5 μm. The average particle diameter may be measured using, for example, a Model 1064LD particle size analyzer (CILAS Co., Ltd.) after dispersing the conductive powder in isopropyl alcohol (IPA) at 25° C. for 3 minutes via ultrasonication. Within this range of average particle diameter, the composition may provide low contact resistance and low line resistance.

The silver powder may be present in an amount of about 60 wt % to about 95 wt % based on the total weight of the composition. Within this range, the conductive powder may prevent deterioration in conversion efficiency due to an increase in resistance and difficulty in forming the paste due to relative reduction in amount of the organic vehicle. For example, the conductive powder may be present in an amount of about 70 wt % to about 90 wt %.

Glass Fit

The glass frit may help enhance adhesion between the conductive powder and the wafer or the substrate and may help promote the formation of silver crystal grains in an emitter region by etching an anti-reflection layer and melting the silver powder. During the baking process of the composition for electrodes, contact resistance may be reduced. Further, during the baking process, the glass frit may soften and decrease the baking temperature.

When the area of the solar cell is increased in order to improve solar cell efficiency, solar cell contact resistance may increase. Thus, it is desirable to minimize both serial resistance (Rs) and influence on the p-n junction. In addition, the baking temperatures may vary within a broad range with increasing use of various wafers having different sheet resistances. Accordingly, it is desirable that the glass frit possess sufficient thermal stability to withstand a wide range of baking temperatures.

The glass fit may be formed of a silver (Ag) compound and a metal oxide. The glass frit may be prepared by mixing, melting, and pulverizing a silver compound having a decomposition temperature of about 1,000° C. or less at which the silver compound is decomposed into Ag ions, and a metal oxide. The metal oxide may include at least one kind of metal oxide.

The silver compound may be an ionic compound. The silver compound may include silver cyanide (AgCN), silver nitrate (AgNO₃), silver halide (Ag—X), silver carbonate (Ag₂CO₃), silver acetate, or mixtures thereof. In the silver halide, X may be iodine, fluorine, chlorine, or bromine. For example, X may be iodine.

In one embodiment, the metal oxide may include at least one of lead (Pb) oxide and bismuth (Bi) oxide.

In another embodiment, the metal oxide may further include at least one metal oxide selected from tellurium (Te), phosphorus (P), germanium (Ge), gallium (Ga), cerium (Ce), iron (Fe), lithium (Li), silicon (Si), zinc (Zn), tungsten (W), magnesium (Mg), cesium (Cs), strontium (Sr), molybdenum (Mo), titanium (Ti), tin (Sn), indium (In), vanadium (V), ruthenium (Ru), barium (Ba), nickel (Ni), copper (Cu), sodium (Na), potassium (K), arsenic (As), cobalt (Co), zirconium (Zr), manganese (Mn), neodymium (Nd), chromium (Cr), and aluminum (Al) oxides.

The glass frit formed of the silver compound and the metal oxide according to embodiments may include silver (Ag) and lead (Pb). The mole ratio of Ag to Pb in the glass frit may range from about 1:0.1 to about 1:50. Within this range, it may be possible to ensure low serial resistance and contact resistance. The term mole ratio, as used herein, refers to an elemental mole ratio of each metal.

By way of another example, the glass frit may include silver (Ag) and bismuth (Bi). An electrode prepared by printing and baking a composition for solar cell electrodes including the glass frit may have a mole ratio of Ag to Bi in the glass frit ranging from about 1:0.1 to about 1:20. Within this range, it may be possible to ensure low serial resistance and contact resistance.

By way of a further example, the glass frit may include silver (Ag) and tellurium (Te). An electrode prepared by printing and baking a composition for solar cell electrodes including the glass frit may have a mole ratio of Ag to Te in the glass frit ranging from about 1:0.1 to about 1:25. Within this range, it may be possible to ensure low serial resistance and contact resistance.

By way of still another example, the glass frit may further include at least one element selected from phosphorus (P), germanium (Ge), gallium (Ga), cerium (Ce), iron (Fe), lithium (Li), silicon (Si), zinc (Zn), tungsten (W), magnesium (Mg), cesium (Cs), strontium (Sr), molybdenum (Mo), titanium (Ti), tin (Sn), indium (In), vanadium (V), barium (Ba), nickel (Ni), copper (Cu), sodium (Na), potassium (K), arsenic (As), cobalt (Co), zirconium (Zr), manganese (Mn), and aluminum (Al).

The glass frit may contain about 0.1 mole % to about 50 mole % of elemental silver, for example, about 0.5 mole % to about 40 mole % of elemental silver, based on the total moles of the glass frit.

The content of each metal, contained in the glass frit in elemental form, may be measured by Inductively Coupled Plasma-Optical Emission Spectroscopy (ICP-OES). ICP-OES uses very small sample amounts, and thus may shorten a sample set-up time and reduce errors due to pre-treatment of the sample while providing excellent analytical sensitivity.

Specifically, ICP-OES may include pre-treating a sample, preparing a standard solution, and calculating the content of each element in a glass frit by measuring and converting the concentrations of target elements, thereby enabling accurate measurement of the content of each element in the glass frit.

In operation of pre-treating a sample, a predetermined amount of the sample may be dissolved in an acid solution capable of dissolving a sample glass frit, and then heated for carbonization. The acid solution may include, for example, a sulfuric acid (H₂SO₄) solution.

The carbonized sample may be diluted with a solvent, such as distilled water or hydrogen peroxide (H₂O₂), to an appropriate extent that allows analysis of an element to be analyzed. In view of element detection capability of an ICP-OES tester, the carbonized sample may be diluted by about 10,000 times.

In measurement with the ICP-OES tester, the pre-treated sample may be calibrated using a standard solution, for example, a solution of an element to be analyzed for measuring elements.

By way of example, calculation of the mole ratio of each element in the glass fit may be accomplished by introducing the standard solution into the ICP-OES tester and plotting a calibration curve with an external standard method, followed by measuring and converting the concentration (ppm) of the element to be analyzed in the pre-treated sample using the ICP-OES tester.

The glass frit may be prepared from the silver compound and the metal oxide, as described above, by any suitable method. For example, the silver compound and the metal oxide may be mixed in a predetermined ratio. Mixing may be carried out using a ball mill or a planetary mill. The mixture may be melted at about 800° C. to about 1,300° C., followed by quenching to about 25° C. The obtained resultant may be subjected to pulverization using a disc mill, a planetary mill, or the like, thereby preparing a glass frit.

The glass frit may have an average particle diameter (D50) of about 0.1 μm to about 10 μm, and may have a spherical or amorphous shape.

The glass frit may be present in an amount of about 0.1 wt % to about 20 wt %, for example, about 0.5 wt % to about 10 wt %, based on the total weight of the composition. Within this range, it may be possible to secure p-n junction stability given varying surface resistances while minimizing serial resistance so as to improve solar cell efficiency.

Organic Vehicle

The organic vehicle may impart suitable viscosity and rheological characteristics for printing to the composition for solar cell electrodes through mechanical mixing with the inorganic component of the composition.

The organic vehicle may be any suitable organic vehicle for use in solar cell electrode compositions. The organic vehicle may include a binder resin, a solvent, or the like.

The binder resin may be selected from acrylate resins or cellulose resins. Ethylcellulose may be used as the binder resin. In other implementations, the binder resin may be selected from ethyl hydroxyethylcellulose, nitrocellulose, a mixture of ethylcellulose and a phenol resin, an alkyd resin, a phenolic resin, an acrylic acid ester resin, a xylenol resin, a polybutene resin, a polyester resin, a urea resin, a melamine resin, a vinyl acetate resin, wood rosin, polymethacrylate, and the like.

The solvent may be selected from, for example, hexane, toluene, ethyl cellosolve, cyclohexanone, butyl cellosolve, butyl carbitol (diethylene glycol monobutyl ether), dibutyl carbitol (diethylene glycol dibutyl ether), butyl carbitol acetate (diethylene glycol monobutyl ether acetate), propylene glycol monomethyl ether, hexylene glycol, terpineol, methylethylketone, benzylalcohol, γ-butyrolactone, ethyl lactate, and combinations thereof.

The organic vehicle may be present in an amount of about 1 wt % to about 30 wt % based on the total weight of the composition. Within this range, the organic vehicle may provide sufficient adhesive strength and excellent printability to the composition.

Additives

The composition may further include suitable additives to enhance flow and process properties and stability, as desired. The additives may include dispersants, thixotropic agents, plasticizers, viscosity stabilizers, anti-foaming agents, pigments, UV stabilizers, antioxidants, coupling agents, and the like, as examples. These additives may be used alone or as mixtures thereof. These additives may be present in the composition in an amount of, for example, about 0.1 wt % to about 5 wt %.

Solar Cell Electrode and Solar Cell Including the Same

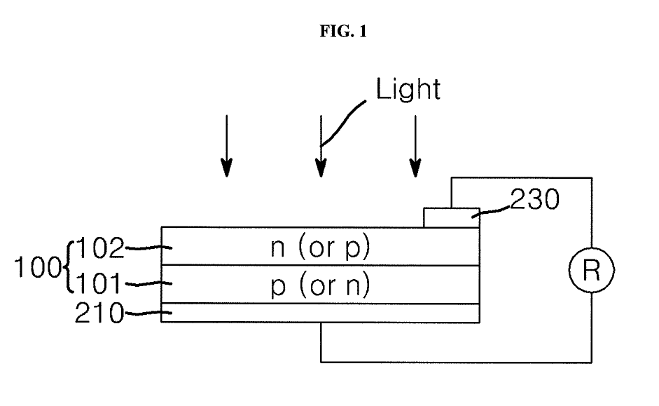

Embodiments also relate to an electrode formed from the composition for solar cell electrodes and a solar cell including the same. FIG. 1 illustrates a solar cell in accordance with an embodiment.

Referring to FIG. 1, a rear electrode 210 and a front electrode 230 may be formed by printing and baking the composition on a wafer 100 or substrate that includes a p-layer (or p-layer) 101 and an n-layer (or p-layer) 102, which will serve as an emitter. For example, a preliminary process of preparing the rear electrode 210 may be performed by printing the composition on the rear surface of the wafer 100 and drying the printed composition at about 200° C. to about 400° C. for about 10 seconds to about 60 seconds. A preliminary process for preparing the front electrode may be performed by printing the paste on the front surface of the wafer and drying the printed composition. The front electrode 230 and the rear electrode 210 may be formed by baking the wafer at about 400° C. to about 950° C., for example, at about 750° C. to about 950° C., for about 30 seconds to about 210 seconds.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### EXAMPLES 1 to 90 and COMPARATIVE EXAMPLES 1 to 2

### Example 1

As an organic binder, 3.0 wt % of ethylcellulose (STD4, Dow Chemical Company) was sufficiently dissolved in 6.5 wt % of butyl carbitol at 60° C., and 86.90 wt % of spherical silver powder (AG-4-8, Dowa Hightech Co., Ltd.) having an average particle diameter of 2.0 μm, 3.1 wt % of a glass frit derived from silver cyanide (AgCN) as a silver compound and prepared according to the composition as listed in Table 1, 0.2 wt % of a dispersant BYK102 (BYK-chemie), and 0.3 wt % of a thixotropic agent Thixatrol ST (Elementis Co., Ltd.) were added to the binder solution, followed by mixing and kneading in a 3-roll kneader, thereby preparing a composition for solar cell electrodes.

### Examples 2 to 15

Compositions for solar cell electrodes were prepared in the same manner as in Example 1 except that the glass frits were prepared according to the compositions as listed in Table 1.

### Examples 16 to 30

Compositions for solar cell electrodes were prepared in the same manner as in Example 1 except that glass frits containing silver nitrate (AgNO₃) as a silver compound were prepared according to the compositions as listed in Table 2.

### Examples 31 to 45

Compositions for solar cell electrodes were prepared in the same manner as in Example 1 except that glass frits containing silver iodide (AgI) as a silver compound were prepared according to the compositions as listed in Table 3.

### Examples 46 to 60

Compositions for solar cell electrodes were prepared in the same manner as in Example 1 except that glass fits containing silver nitrate (AgNO₃) as a silver compound were prepared according to the compositions as listed in Table 4.

### Examples 61 to 75

Compositions for solar cell electrodes were prepared in the same manner as in Example 1 except that glass frits containing silver carbonate (Ag₂CO₃) as a silver compound were prepared according to the compositions as listed in Table 5.

### Examples 76 to 90

Compositions for solar cell electrodes were prepared in the same manner as in Example 1 except that glass frits containing silver iodide (AgI) as a silver compound were prepared according to the compositions as listed in Table 6.

### Comparative Examples 1 to 2

Compositions for solar cell electrodes were prepared in the same manner as in Example 1 except that the glass frits were prepared according to the compositions as listed in Table 7.

It is to be understood that Tables 1 to 7 represent the composition of the glass frits according to Examples 1 to 90 and Comparative Examples 1 and 2 before melting is carried out to decompose the silver compound to elemental silver.

Measurement of Mole Ratio of Ag:Pb and Ag:Bi in Glass Fit Using ICP-OES

Pretreatment of samples: 0.5 g of a glass fit sample to be analyzed was placed in a beaker and weighed an accuracy of 0.0001 g. 5 ml of sulfuric acid (H₂SO₄) was added to the beaker, followed by heating at 220° C. for about 3 hours using a hot plate until the sample was completely carbonized. Hydrogen peroxide (H₂O₂) was added to the beaker until the beaker containing the carbonized sample became transparent, thereby completing pretreatment.

Preparation of standard solution: Standard solutions of elemental silver (Ag), elemental lead (Pb), and elemental bismuth (Bi), which are elements to be analyzed, were prepared.

Measurement of mole ratio of Ag:Pb and Ag:Bi: Nitric acid (HNO₃) was added to the beaker containing the pre-treated sample, followed by heating for 5 minutes and air-cooling. The prepared standard solution was introduced into an ICP-OES tester (PerkinElmer, Inc.) and a calibration curve was plotted by an external standard method, followed by measuring and converting the concentration (ppm) of the elemental silver (Ag), lead (Pb), and bismuth (Bi) in the sample using the ICP-OES tester, thereby calculating the mole ratio of Ag:Pb and Ag:Bi in the glass frit. Representative results are shown in Table 8 and 9.

Content of each element(%)=Concentration of each element(ppm)×Dilution Factor(DF)/10,000

Mole of each elemental=Content of each element/Molecular weight of each element

Mole ratio of Ag:Pb=1:(Mole of Pb/Mole of Ag)

Mole ratio of Ag:Bi=1:(Mole of Bi/Mole of Ag)

TABLE 1

| | Composition of glass frit (unit: wt %) | | | | | | | | | | | | | |
|---|---|---|---|---|---|---|---|---|---|---|---|---|---|---|
| □ | AgCN | PbO | Bi₂O₃ | TeO₂ | P₂O₅ | Li₂CO₃ | SiO₂ | ZnO | WO₃ | Nd₂O₃ | MgO | Na₂CO₃ | Sb₂O₃ | Cr₂O₃ |
| Example 1 | 5 | 42 | 40 | — | — | 2 | 3 | 5 | — | — | — | 3 | — | — |
| Example 2 | 15 | 42 | 30 | — | — | 2 | 3 | 5 | 3 | — | — | — | — | — |
| Example 3 | 30 | 32 | 20 | — | — | 2 | 8 | 5 | — | 3 | — | — | — | — |
| Example 4 | 5 | 40 | — | 50 | — | 2 | 3 | — | — | — | — | — | — | — |
| Example 5 | 15 | 30 | — | 49 | — | 2 | 3 | — | — | — | — | — | 1 | — |
| Example 6 | 30 | 18 | — | 40 | — | 2 | 8 | — | — | — | — | — | 2 | — |
| Example 7 | 5 | 40 | — | 40 | 10 | 2 | 3 | — | — | — | — | — | — | — |
| Example 8 | 15 | 30 | — | 45 | — | 2 | 3 | 5 | — | — | — | — | — | — |
| Example 9 | 30 | 20 | — | 38 | — | 2 | 8 | — | — | — | 2 | — | — | — |
| Example 10 | 5 | 40 | — | 47 | — | 2 | 3 | — | — | 3 | — | — | — | — |
| Example 11 | 15 | 35 | — | 34 | — | 2 | 3 | 11 | — | — | — | — | — | — |
| Example 12 | 30 | 30 | — | 27 | — | 2 | 8 | — | 3 | — | — | — | — | — |
| Example 13 | 5 | 47 | 40 | — | — | 2 | 3 | — | — | — | — | 3 | — | — |
| Example 14 | 15 | 42 | 35 | — | — | 2 | 3 | — | — | — | — | 3 | — | — |
| Example 15 | 30 | 37 | 20 | — | — | 2 | 8 | — | — | — | — | 3 | — | — |

TABLE 2

| | Composition of glass frit (unit: wt %) | | | | | | | | | | | | | |
|---|---|---|---|---|---|---|---|---|---|---|---|---|---|---|
| □ | AgNO₃ | PbO | Bi₂O₃ | TeO₂ | P₂O₅ | Li₂CO₃ | SiO₂ | ZnO | WO₃ | Nd₂O₃ | MgO | Na₂CO₃ | Sb₂O₃ | Cr₂O₃ |
| Example 16 | 5 | 39 | — | 41 | — | 2 | 3 | 7 | — | 2 | — | — | 1 | — |
| Example 17 | 15 | 35 | — | 33 | — | 2 | 3 | 7 | — | 3 | 2 | — | — | — |
| Example 18 | 30 | 20 | — | 29 | — | 3 | 8 | 7 | — | 3 | — | — | — | — |
| Example 19 | 5 | 50 | — | 9 | — | 2 | 3 | 16 | — | — | 8 | — | — | 7 |
| Example 20 | 15 | 45 | — | — | — | 2 | 3 | 17 | 6 | 5 | 2 | 5 | — | — |
| Example 21 | 30 | 30 | — | — | — | 2 | 8 | 25 | — | 2 | — | 3 | — | — |
| Example 22 | 5 | 40 | — | 50 | — | 2 | 2 | — | 1 | — | — | — | — | — |
| Example 23 | 15 | 35 | — | 42 | — | 5 | 2 | — | — | — | 1 | — | — | — |
| Example 24 | 30 | 20 | — | 40 | — | 2 | 5 | — | — | 3 | — | — | — | — |
| Example 25 | 5 | 40 | 21 | 20 | 6 | 2 | 2 | 4 | — | — | — | — | — | — |
| Example 26 | 15 | 45 | 29 | 2 | 5 | 2 | 2 | — | — | — | — | — | — | — |
| Example 27 | 30 | 39 | 19 | 3 | 2 | 2 | 5 | — | — | — | — | — | — | — |
| Example 28 | 5 | 40 | 23 | 17 | — | 2 | 2 | — | — | — | — | — | — | 11 |
| Example 29 | 15 | 27 | 17 | 21 | — | 2 | 2 | — | — | — | — | — | — | 16 |
| Example 30 | 30 | 28 | 12 | 10 | — | 2 | 5 | — | — | — | — | — | — | 13 |

TABLE 3

| | Composition of glass frit (unit: wt %) | | | | | | | | | | | | | |
|---|---|---|---|---|---|---|---|---|---|---|---|---|---|---|
| □ | AgI | PbO | Bi₂O₃ | TeO₂ | P₂O₅ | Li₂CO₃ | SiO₂ | ZnO | WO₃ | Nd₂O₃ | MgO | Na₂CO₃ | Sb₂O₃ | Cr₂O₃ |
| Example 31 | 5 | 42 | 40 | — | — | 2 | 3 | 5 | — | — | — | 3 | — | — |
| Example 32 | 15 | 42 | 30 | — | — | 2 | 3 | 5 | 3 | — | — | — | — | — |
| Example 33 | 30 | 32 | 20 | — | — | 2 | 8 | 5 | — | 3 | — | — | — | — |
| Example 34 | 2 | 40 | — | 53 | — | 2 | 3 | — | — | — | — | — | — | — |
| Example 35 | 15 | 35 | — | 45 | — | 2 | 3 | — | — | — | — | — | — | — |
| Example 36 | 30 | 20 | — | 40 | — | 2 | 8 | — | — | — | — | — | — | — |
| Example 37 | 5 | 50 | 40 | — | — | 2 | 3 | — | — | — | — | — | — | — |
| Example 38 | 15 | 48 | 32 | — | — | 2 | 3 | — | — | — | — | — | — | — |
| Example 39 | 30 | 30 | 30 | — | — | 2 | 8 | — | — | — | — | — | — | — |
| Example 40 | 5 | 40 | — | 42 | — | 2 | 3 | 5 | — | — | — | 3 | — | — |
| Example 41 | 15 | 35 | — | 37 | — | 2 | 3 | 5 | 3 | — | — | — | — | — |
| Example 42 | 30 | 30 | — | 22 | — | 2 | 8 | 5 | — | 3 | — | — | — | — |
| Example 43 | 5 | 36 | 40 | — | — | 2 | 3 | 9 | — | 2 | 3 | — | — | — |
| Example 44 | 15 | 34 | 35 | — | — | 2 | 3 | 8 | — | 3 | — | — | — | — |
| Example 45 | 30 | 27 | 20 | — | — | 2 | 8 | 13 | — | — | — | — | — | — |

TABLE 4

| | Composition of glass frit (unit: wt %) | | | | | | | | | | | | | |
|---|---|---|---|---|---|---|---|---|---|---|---|---|---|---|
| □ | AgNO₃ | PbO | Bi₂O₃ | TeO₂ | P₂O₅ | Li₂CO₃ | SiO₂ | ZnO | WO₃ | Nd₂O₃ | MgO | Na₂CO₃ | Sb₂O₃ | Cr₂O₃ |
| Example 46 | 5 | 40 | 39 | — | — | 2 | 3 | 11 | — | — | — | — | — | — |
| Example 47 | 15 | 35 | 37 | — | — | 2 | 3 | 8 | — | — | — | — | — | — |
| Example 48 | 30 | 30 | 21 | — | — | 2 | 8 | 9 | — | — | — | — | — | — |
| Example 49 | 6 | — | 40 | 41 | — | 2 | 3 | 5 | — | — | — | 3 | — | — |
| Example 50 | 15 | — | 35 | 37 | — | 2 | 3 | 5 | 3 | — | — | — | — | — |
| Example 51 | 30 | — | 20 | 32 | — | 2 | 8 | 5 | — | 3 | — | — | — | — |
| Example 52 | 5 | 36 | 54 | — | — | 2 | 3 | — | — | — | — | — | — | — |
| Example 53 | 15 | 35 | 45 | — | — | 2 | 3 | — | — | — | — | — | — | — |
| Example 54 | 30 | 20 | 40 | — | — | 2 | 8 | — | — | — | — | — | — | — |
| Example 55 | 5 | — | 50 | 10 | — | 2 | 3 | 17 | — | 5 | 3 | 5 | — | — |
| Example 56 | 15 | — | 45 | 10 | — | 2 | 3 | 18 | 7 | — | — | — | — | — |
| Example 57 | 30 | — | 30 | — | — | 2 | 8 | 12 | 10 | 3 | 5 | — | — | — |
| Example 58 | 5 | — | 40 | 50 | — | 2 | 2 | — | 1 | — | — | — | — | — |
| Example 59 | 15 | — | 35 | 45 | — | 2 | 2 | — | — | — | 1 | — | — | — |
| Example 60 | 30 | — | 30 | 30 | — | 2 | 5 | — | — | 3 | — | — | — | — |

TABLE 5

| | Composition of glass frit (unit: wt %) | | | | | | | | | | | | | |
|---|---|---|---|---|---|---|---|---|---|---|---|---|---|---|
| □ | Ag₂CO₃ | PbO | Bi₂O₃ | TeO₂ | P₂O₅ | Li₂CO₃ | SiO₂ | ZnO | WO₃ | Nd₂O₃ | MgO | Na₂CO₃ | Sb₂O₃ | Cr₂O₃ |
| Example 61 | 5 | 40 | 49 | — | — | 2 | 3 | — | — | — | — | — | 1 | — |
| Example 62 | 15 | 35 | 45 | — | — | 2 | 3 | — | — | — | — | — | — | — |
| Example 63 | 30 | 20 | 40 | — | — | 2 | 8 | — | — | — | — | — | — | — |
| Example 64 | 5 | 3 | 50 | — | — | 2 | 3 | 19 | — | 5 | 3 | — | — | 10 |
| Example 65 | 15 | 5 | 45 | — | — | 2 | 3 | 21 | — | 5 | 4 | — | — | — |
| Example 66 | 30 | — | 32 | — | — | 2 | 8 | 15 | 3 | 3 | 5 | 2 | — | — |
| Example 67 | 5 | — | 40 | 50 | — | 2 | 2 | — | 1 | — | — | — | — | — |
| Example 68 | 15 | — | 35 | 45 | — | 2 | 2 | — | — | — | 1 | — | — | — |
| Example 69 | 30 | — | 20 | 40 | — | 2 | 5 | — | — | 3 | — | — | — | — |
| Example 70 | 5 | 40 | 40 | 11 | — | 2 | 2 | — | — | — | — | — | — | — |
| Example 71 | 15 | 30 | 35 | 10 | — | 2 | 2 | 6 | — | — | — | — | — | — |
| Example 72 | 30 | 20 | 30 | 10 | — | 2 | 5 | — | — | 3 | — | — | — | — |
| Example 73 | 5 | — | 40 | 40 | — | 2 | 2 | — | — | — | — | — | — | 11 |
| Example 74 | 15 | — | 30 | 35 | — | 2 | 2 | — | — | — | — | — | — | 16 |
| Example 75 | 30 | — | 25 | 25 | — | 2 | 5 | — | — | — | — | — | — | 13 |

TABLE 6

| | Composition of glass frit (unit: wt %) | | | | | | | | | | | | | |
|---|---|---|---|---|---|---|---|---|---|---|---|---|---|---|
| □ | AgI | PbO | Bi₂O₃ | TeO₂ | P₂O₅ | Li₂CO₃ | SiO₂ | ZnO | WO₃ | Nd₂O₃ | MgO | Na₂CO₃ | Sb₂O₃ | Cr₂O₃ |
| Example 76 | 5 | 40 | 40 | 11 | — | 2 | 2 | — | — | — | — | — | — | — |
| Example 77 | 15 | 35 | 30 | 16 | — | 2 | 2 | — | — | — | — | — | — | — |
| Example 78 | 30 | 25 | 25 | 13 | — | 2 | 5 | — | — | — | — | — | — | — |
| Example 79 | 10 | — | 28 | 35 | — | 2 | 2 | 7 | — | 5 | — | — | — | 11 |
| Example 80 | 20 | — | 24 | 25 | — | 2 | 2 | 9 | — | 2 | — | — | — | 16 |
| Example 81 | 30 | — | 32 | 26 | — | 2 | 2 | 2 | — | 3 | — | — | — | 3 |
| Example 82 | 5 | — | 40 | 49 | — | 2 | — | 3 | — | — | — | — | 1 | — |
| Example 83 | 15 | — | 35 | 45 | — | 2 | — | 3 | — | — | — | — | — | — |
| Example 84 | 30 | — | 20 | 40 | — | 2 | — | 8 | — | — | — | — | — | — |
| Example 85 | 5 | 50 | 40 | 2 | — | 2 | — | — | 1 | — | — | — | — | — |
| Example 86 | 15 | 50 | 30 | — | — | 2 | — | — | — | — | 1 | — | — | 2 |
| Example 87 | 30 | 35 | 25 | 5 | — | 2 | — | — | — | 3 | — | — | — | — |
| Example 88 | 5 | 50 | 40 | — | — | 2 | — | 3 | — | — | — | — | — | — |
| Example 89 | 15 | 45 | 35 | — | — | 2 | — | 3 | — | — | — | — | — | — |
| Example 90 | 30 | 40 | 20 | — | — | 2 | — | 8 | — | — | — | — | — | — |

TABLE 7

| | Composition of glass frit (unit: wt %) | | | | | | | | | | | |
|---|---|---|---|---|---|---|---|---|---|---|---|---|
| | Ag₂CO₃ | PbO | Bi₂O₃ | TeO₂ | P₂O₅ | Li₂CO₃ | SiO₂ | ZnO | WO₃ | Nd₂O₃ | MgO | Na₂CO₃ |
| Comparative | 1 | 50 | 39 | — | — | 2 | 5 | — | — | 3 | — | — |
| Example 1 | | | | | | | | | | | | |
| Comparative | — | 35 | — | 25 | — | 2 | 8 | 15 | 7 | 5 | 3 | — |
| Example 2 | | | | | | | | | | | | |

TABLE 8

| | Mole ratio |
|---|---|
| □ | (Ag:Pb) |
| Example 1 | 1:9.12 |
| Example 2 | 1:3.62 |
| Example 3 | 1:1.13 |
| Example 4 | 1:8.42 |
| Example 5 | 1:2.59 |
| Example 6 | 1:0.63 |
| Comparative | 1:57 |
| Example 1 | |
| Example 22 | 1:11.95 |
| Example 23 | 1:3.11 |
| Example 24 | 1:1.02 |
| Example 25 | 1:11.12 |
| Example 26 | 1:4.78 |
| Example 27 | 1:1.49 |

TABLE 9

| | Mole ratio |
|---|---|
| □ | (Ag:Bi) |
| Example 55 | 1:14.75 |
| Example 56 | 1:3.98 |
| Example 57 | 1:1.58 |
| Example 58 | 1:11.05 |
| Example 59 | 1:3.95 |
| Example 60 | 1:1.32 |
| Comparative | 1:44.7 |
| Example 1 | |
| Example 76 | 1:15.11 |
| Example 77 | 1:3.85 |
| Example 78 | 1:1.45 |
| Example 79 | 1:5.42 |
| Example 80 | 1:2.56 |
| Example 81 | 1:2.01 |

Measurement Method of Contact Resistance

The compositions prepared in the examples and comparative examples were deposited onto a front surface of a crystalline mono-wafer by screen-printing in a predetermined pattern, followed by drying in an IR drying furnace. Cells formed according to this procedure were subjected to baking at 700° C. to 950° C. for 30 seconds to 210 seconds in a belt-type baking furnace, and then evaluated as to contact resistance (Rc) using a TLM (Transfer Length Method) tester. The measured results are shown in Table 10 to 16.

Measurement Method of Serial Resistance, Fill Factor, and Conversion Efficiency

The compositions prepared in the examples and comparative examples were deposited over a front surface of a crystalline mono-wafer by screen-printing in a predetermined pattern, followed by drying in an IR drying furnace. Then, the aluminum paste was printed on a rear side of the wafer and dried in the same manner as above. Cells formed according to this procedure were subjected to baking at 700° C. to 950° C. for 30 seconds to 210 seconds in a belt-type baking furnace, and evaluated as to serial resistance (Rs), Fill Factor (FF, %), and conversion efficiency (%) using a solar cell efficiency tester CT-801 (Pasan Co., Ltd.). The measured serial resistance, fill factor, and conversion efficiency are shown in Table 10 to 16

TABLE 10

| | Contact | Serial | | |
|---|---|---|---|---|
| | Resistance | Resistance | | Efficiency |
| | (mΩ) | (mΩ) | Fill Factor | (%) |
| Example 1 | 0.577014 | 5.72 | 76.09 | 16.24 |
| Example 2 | 0.513507 | 5.55 | 76.38 | 16.45 |
| Example 3 | 0.426872 | 5.15 | 76.78 | 16.83 |
| Example 4 | 0.555701 | 5.64 | 76.22 | 16.34 |
| Example 5 | 0.508865 | 5.54 | 76.39 | 16.48 |
| Example 6 | 0.415771 | 5.15 | 76.79 | 16.83 |
| Example 7 | 0.531488 | 5.61 | 76.30 | 16.42 |
| Example 8 | 0.467723 | 5.36 | 76.58 | 16.67 |
| Example 9 | 0.400486 | 5.08 | 76.85 | 16.93 |
| Example 10 | 0.569828 | 5.68 | 76.20 | 16.32 |
| Example 11 | 0.505302 | 5.54 | 76.39 | 16.49 |
| Example 12 | 0.398880 | 5.08 | 76.90 | 16.94 |
| Example 13 | 0.550385 | 5.63 | 76.26 | 16.40 |
| Example 14 | 0.492216 | 5.44 | 76.50 | 16.57 |
| Example 15 | 0.375978 | 5.07 | 76.94 | 16.95 |

TABLE 11

| | Contact | Serial | | |
|---|---|---|---|---|
| | Resistance | Resistance | | Efficiency |
| | (mΩ) | (mΩ) | Fill Factor | (%) |
| Example 16 | 0.593497 | 5.76 | 76.07 | 16.14 |
| Example 17 | 0.497407 | 5.51 | 76.43 | 16.52 |
| Example 18 | 0.415771 | 5.15 | 76.79 | 16.83 |
| Example 19 | 0.563355 | 5.68 | 76.21 | 16.32 |
| Example 20 | 0.477034 | 5.43 | 76.53 | 16.61 |
| Example 21 | 0.414946 | 5.14 | 76.79 | 16.87 |
| Example 22 | 0.556712 | 5.65 | 76.22 | 16.33 |
| Example 23 | 0.489483 | 5.44 | 76.50 | 16.59 |
| Example 24 | 0.413460 | 5.12 | 76.80 | 16.88 |
| Example 25 | 0.559818 | 5.66 | 76.21 | 16.33 |
| Example 26 | 0.476373 | 5.40 | 76.54 | 16.62 |
| Example 27 | 0.429870 | 5.18 | 76.78 | 16.82 |
| Example 28 | 0.552543 | 5.63 | 76.23 | 16.35 |
| Example 29 | 0.482105 | 5.43 | 76.52 | 16.61 |
| Example 30 | 0.409445 | 5.11 | 76.81 | 16.89 |

TABLE 12

| | Contact | Serial | | |
|---|---|---|---|---|
| | Resistance | Resistance | | Efficiency |
| | (mΩ) | (mΩ) | Fill Factor | (%) |
| Example 31 | 0.527919 | 5.57 | 76.32 | 16.42 |
| Example 32 | 0.466635 | 5.34 | 76.59 | 16.68 |
| Example 33 | 0.430287 | 5.24 | 76.77 | 16.80 |
| Example 34 | 0.570086 | 5.70 | 76.17 | 16.31 |
| Example 35 | 0.470686 | 5.37 | 76.56 | 16.67 |
| Example 36 | 0.375978 | 5.07 | 76.94 | 16.95 |
| Example 37 | 0.545513 | 5.62 | 76.27 | 16.41 |
| Example 38 | 0.454954 | 5.31 | 76.61 | 16.72 |
| Example 39 | 0.403092 | 5.09 | 76.83 | 16.93 |
| Example 40 | 0.542335 | 5.62 | 76.27 | 16.41 |
| Example 41 | 0.467234 | 5.35 | 76.58 | 16.68 |
| Example 42 | 0.318050 | 4.91 | 77.07 | 16.99 |
| Example 43 | 0.571934 | 5.72 | 76.14 | 16.29 |
| Example 44 | 0.494979 | 5.48 | 76.47 | 16.52 |
| Example 45 | 0.288595 | 4.70 | 77.12 | 17.05 |

TABLE 13

| | Contact | Serial | | |
|---|---|---|---|---|
| | Resistance | Resistance | | Efficiency |
| | (mΩ) | (mΩ) | Fill Factor | (%) |
| Example 46 | 0.576456 | 5.72 | 76.09 | 16.28 |
| Example 47 | 0.471093 | 5.37 | 76.55 | 16.64 |
| Example 48 | 0.459007 | 5.33 | 76.61 | 16.70 |
| Example 49 | 0.632353 | 5.81 | 75.94 | 16.10 |
| Example 50 | 0.500853 | 5.52 | 76.41 | 16.50 |
| Example 51 | 0.296191 | 4.76 | 77.11 | 17.04 |
| Example 52 | 0.530392 | 5.59 | 76.31 | 16.42 |
| Example 53 | 0.485063 | 5.44 | 76.50 | 16.59 |
| Example 54 | 0.430244 | 5.23 | 76.78 | 16.82 |
| Example 55 | 0.615784 | 5.78 | 75.95 | 16.10 |
| Example 56 | 0.461353 | 5.33 | 76.61 | 16.69 |
| Example 57 | 0.304024 | 4.87 | 77.10 | 17.01 |
| Example 58 | 0.519728 | 5.56 | 76.36 | 16.44 |
| Example 59 | 0.462480 | 5.33 | 76.61 | 16.69 |
| Example 60 | 0.336165 | 4.96 | 76.97 | 16.97 |

TABLE 14

| | Contact | Serial | | |
|---|---|---|---|---|
| | Resistance | Resistance | | Efficiency |
| | (mΩ) | (mΩ) | Fill Factor | (%) |
| Example 61 | 0.636046 | 5.82 | 75.91 | 16.08 |
| Example 62 | 0.492923 | 5.46 | 76.48 | 16.54 |
| Example 63 | 0.255562 | 4.64 | 77.12 | 17.06 |
| Example 64 | 0.583850 | 5.73 | 76.08 | 16.22 |
| Example 65 | 0.471772 | 5.37 | 76.54 | 16.64 |
| Example 66 | 0.354366 | 5.05 | 76.95 | 16.95 |
| Example 67 | 0.583850 | 5.73 | 76.08 | 16.22 |
| Example 68 | 0.492747 | 5.46 | 76.50 | 16.57 |
| Example 69 | 0.407494 | 5.11 | 76.82 | 16.89 |
| Example 70 | 0.529770 | 5.58 | 76.32 | 16.42 |
| Example 71 | 0.463415 | 5.34 | 76.59 | 16.68 |
| Example 72 | 0.352065 | 5.05 | 76.96 | 16.95 |
| Example 73 | 0.585764 | 5.75 | 76.08 | 16.22 |
| Example 74 | 0.443503 | 5.29 | 76.66 | 16.76 |
| Example 75 | 0.337518 | 5.01 | 76.96 | 16.96 |

TABLE 15

| | Contact | Serial | | |
|---|---|---|---|---|
| | Resistance | Resistance | | Efficiency |
| | (mΩ) | (mΩ) | Fill Factor | (%) |
| Example 76 | 0.588265 | 5.76 | 76.08 | 16.21 |
| Example 77 | 0.482105 | 5.43 | 76.52 | 16.61 |
| Example 78 | 0.431533 | 5.25 | 76.76 | 16.80 |
| Example 79 | 0.610960 | 5.78 | 75.97 | 16.11 |
| Example 80 | 0.466635 | 5.34 | 76.59 | 16.68 |
| Example 81 | 0.320913 | 4.95 | 76.98 | 16.98 |
| Example 82 | 0.523928 | 5.57 | 76.33 | 16.43 |
| Example 83 | 0.440178 | 5.28 | 76.67 | 16.76 |
| Example 84 | 0.317017 | 4.90 | 77.09 | 17.00 |
| Example 85 | 0.520825 | 5.56 | 76.33 | 16.43 |
| Example 86 | 0.450973 | 5.31 | 76.61 | 16.72 |
| Example 87 | 0.289531 | 4.73 | 77.12 | 17.05 |
| Example 88 | 0.516887 | 5.56 | 76.36 | 16.45 |
| Example 89 | 0.446569 | 5.30 | 76.65 | 16.75 |
| Example 90 | 0.278027 | 4.67 | 77.14 | 17.11 |

TABLE 16

| | Contact | Serial | | |
|---|---|---|---|---|
| | Resistance | Resistance | | Efficiency |
| | (mΩ) | (mΩ) | Fill Factor | (%) |
| Comparative | 0.862755 | 7.94 | 73.64 | 15.20 |
| Example 1 | | | | |
| Comparative | 0.943858 | 9.83 | 72.88 | 14.77 |
| Example 2 | | | | |

As shown in Table 10 to 16, it could be seen that the solar cell electrodes fabricated using the compositions prepared using the glass frits that have a mole ratio of Ag:Pb ranging from 1:0.1 to 1:50 or a mole ratio of Ag:Bi ranging from 1:0.1 to 1:20 in Examples 1 to 90 had a considerably lower contact resistance and serial resistance, thereby providing excellent fill factor and conversion efficiency, as compared with the solar cell electrodes of Comparative Example 1 in which the glass fits having a mole ratio of Ag:Pb and Ag:Bi out of the range as described herein were used and Comparative Example 2 in which the glass frits not containing silver were used.

By way of summation and review, a continuous reduction in emitter thickness to improve solar cell efficiency may cause shunting which could deteriorate solar cell performance. In addition, when an area of solar cells is increased to achieve higher efficiency, such efficiency may deteriorate due to an increase in solar cell contact resistance.

Embodiments provide a composition for solar cell electrodes that can enhance contact efficiency between electrodes and a silicon wafer to minimize contact resistance (Rc) and serial resistance (Rs), and thereby provide excellent conversion efficiency. Solar cell electrodes produced from the composition have minimized contact resistance (Rc) and serial resistance (Rs), thereby providing excellent fill factor and conversion efficiency.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope thereof as set forth in the following claims.

What is claimed is:

1. A composition for solar cell electrodes, the composition comprising:
a silver (Ag) powder;
a glass frit containing elemental silver (Ag) and containing at least one of lead (Pb) and bismuth (Bi); and
an organic vehicle, wherein the glass frit has a mole ratio of Ag to Pb ranging from about 1:0.1 to about 1:50, or a mole ratio of Ag to Bi ranging from about 1:0.1 to about 1:20.

2. The composition as claimed in claim 1, wherein the glass frit further includes at least one selected from tellurium (Te), phosphorus (P), germanium (Ge), gallium (Ga), cerium (Ce), iron (Fe), lithium (Li), silicon (Si), zinc (Zn), tungsten (W), magnesium (Mg), cesium (Cs), strontium (Sr), molybdenum (Mo), titanium (Ti), tin (Sn), indium (In), vanadium (V), ruthenium (Ru), barium (Ba), nickel (Ni), copper (Cu), sodium (Na), potassium (K), arsenic (As), cobalt (Co), zirconium (Zr), manganese (Mn), neodymium (Nd), chromium (Cr), and aluminum (Al).

3. The composition as claimed in claim 1, wherein the elemental silver (Ag) originates from at least one silver compound selected from silver cyanide, silver nitrate, silver halide, silver carbonate, and silver acetate.

4. The composition as claimed in claim 1, wherein the glass frit is formed of a silver compound and at least one metal oxide selected from lead (Pb) oxide and bismuth (Bi) oxide.

5. The composition as claimed in claim 4, wherein the metal oxide further includes at least one metal oxide selected from tellurium (Te), phosphorus (P), germanium (Ge), gallium (Ga), cerium (Ce), iron (Fe), lithium (Li), silicon (Si), zinc (Zn), tungsten (W), magnesium (Mg), cesium (Cs), strontium (Sr), molybdenum (Mo), titanium (Ti), tin (Sn), indium (In), vanadium (V), ruthenium (Ru), barium (Ba), nickel (Ni), copper (Cu), sodium (Na), potassium (K), arsenic (As), cobalt (Co), zirconium (Zr), manganese (Mn), neodymium (Nd), chromium (Cr), and aluminum (Al) oxides.

6. The composition as claimed in claim 1, comprising:
about 60 wt % to about 95 wt % of the silver powder;
about 0.1 wt % to about 20 wt % of the glass fit; and
about 1 wt % to about 30 wt % of the organic vehicle.

7. The composition as claimed in claim 1, wherein the glass frit contains about 0.1 mole % to about 50 mole % of the elemental silver (Ag) based on total moles of the glass frit.

8. The composition as claimed in claim 1, wherein the glass frit has an average particle diameter (D50) of about 0.1 μm to about 10 μm.

9. The composition as claimed in claim 1, further including at least one additive selected from a dispersant, a thixotropic agent, a plasticizer, a viscosity stabilizer, an anti-foaming agent, a pigment, a UV stabilizers, an antioxidants, and a coupling agents.

10. A solar cell electrode prepared from the composition for solar cell electrodes as claimed in claim 1.
